(19) United States
(12) Patent Application Publication
(10) Pub. No.: US 2018/0315096 A1
(43) Pub. Date: Nov. 1, 2018

(54) METHOD FOR SHOWING MULTIPLE SKIPPABLE ADS

(71) Applicant: Google LLC, Mountain View, CA (US)

(72) Inventors: Justin Lewis, Marina del Rey, CA (US); Gavin James, Los Angeles, CA (US)

(73) Assignee: Google Inc., Mountain View, CA (US)

(21) Appl. No.: 14/213,619

(22) Filed: Mar. 14, 2014

(51) Int. Cl. G06Q 30/02

(52) U.S. Cl. CPC G06Q 30/0272; G06Q 30/0273

(57) ABSTRACT

In a method and system for showing multiple skippable advertisements, in response to a request for a content item from a user, a set of advertisements for playback with the content item is identified, wherein each of the set of advertisements has a presentation period. A first advertisement of the set of advertisements is presented on a user device, and the user device is instructed to present a skip element concurrently with a presentation of the first advertisement, wherein the skip element, when activated, provides an option for the user to skip the first advertisement prior to an end of a corresponding presentation period. When receiving an indication of the user skipping the first advertisement, a second advertisement of the set of advertisements is presented on the user device, and the user device is instructed to present the skip feature concurrently with a presentation of the second advertisement.

### TECHNICAL FIELD

Aspects of the present disclosure relate to the field of content sharing and, more particularly, to a method for showing skippable advertisement content.

### BACKGROUND

On the Internet, content hosting websites or other applications allow users to upload, view, and share digital content. Such digital content may include audio clips, movie clips, TV clips, and music videos, as well as amateur content such as video blogging, short original videos, pictures, photos, etc.

As a way of generating revenue, advertisements can be associated with the content, where a viewer requesting the content has the option to view the advertisements upon selecting to view the content or is required to view the advertisements to view the content. An organization can pay a fee to have a certain advertisement associated with certain content with the hope that a viewer of the advertisement and the content will be persuaded to purchase the organization's good or services, or otherwise respond in a certain way to the advertisement. However, the advertisement may not be effective because the viewer may determine that viewing the advertisements is not worth the time commitment, that the viewer has seen the same advertisement too many times, or the viewer is not interested in the message of the advertisement. As a result, the viewer may choose to skip the advertisement, if viewing the advertisement is optional, or choose to not view the content, if viewing the advertisement is not optional.

### SUMMARY

In some implementations, a method for showing multiple skippable advertisements is presented. In a method and system for showing multiple skippable advertisements, in response to a request for a content item from a user, a set of advertisements for playback with the content item is identified, wherein each of the set of advertisements has a presentation period. A first advertisement of the set of advertisements is presented on a user device, and the user device is instructed to present a skip element concurrently with a presentation of the first advertisement, wherein the skip element, when activated, provides an option for the user to skip the first advertisement prior to an end of a corresponding presentation period. When receiving an indication of the user skipping the first advertisement, a second advertisement of the set of advertisements is presented on the user device, and the user device is instructed to present the skip feature concurrently with a presentation of the second advertisement. When an indication of the user completing a viewing of the first advertisement is received, whether an advertisement viewing criterion is satisfied is determined and the requested content item is presented on the user device.

In an implementation, the advertisement viewing criterion can be a threshold number of advertisements to be watched prior to a presentation of the content item, each of the number of advertisements to be presented for a corresponding presentation period. The advertisement viewing criterion can be a threshold time period for an advertisement presentation prior to a presentation of the content item. Each of the set of advertisements can have a corresponding value, and the advertisement viewing criterion can be a threshold value.

In an implementation, the skip element can indicate a skip to the next advertisement, the skip element including at least one of a graphical representation of the next advertisement or the title of the next advertisement. The skip element can be modified to indicate a skip to the content item when the next advertisement is presented.

In an implementation, the second advertisement can be selected based on at least one of a presentation period of the second advertisement, a user viewing time of previous advertisements, or a number of previously skipped advertisements. Causing the second advertisement to be presented on the user device can include ensuring that the first advertisement was presented for at least a predefined time period.

In an implementation, the set of advertisements can be formed based on advertiser input indicating advertisements to be shown together, and the set of advertisements can have a sequential order. The method can further include receiving an indication that the user has completed viewing the second advertisement, determining that the second advertisement was presented in response to the user skipping the presentation of the first advertisement, and charging an advertiser of the next advertisement an additional fee.

In some implementations, a method includes receiving a user request for a content item, presenting a first advertisement with a skip element and a time-to-video element, wherein the skip element indicates an option to skip to a next advertisement, and the time-to-video element specifies a time period for skipping to the content item, presenting a second advertisement if a user activates the skip element, and presenting the content item if the user completes viewing the first advertisement, wherein the time period in the time-to-video element is updated while the user is viewing the first advertisement.

### BRIEF DESCRIPTION OF THE DRAWINGS

The present disclosure will be understood more fully from the detailed description given below and from the accompanying drawings of various embodiments of the disclosure.

FIG. 1 illustrates exemplary system architecture, in accordance with one embodiment of the present disclosure.

FIG. 2 illustrates an advertisement system, in accordance with one embodiment of the present disclosure.

FIG. 3A is a flow diagram illustrating one embodiment for a method of showing multiple skippable advertisements.

FIG. 3B is a flow diagram illustrating one embodiment for a method of determining an advertisement fee.

FIG. 3C is a flow diagram illustrating one embodiment for a method of providing multiple skippable advertisements.

FIG. 4 is a user interface for showing multiple skippable advertisements.

FIG. 5 is a block diagram of an exemplary computer system that may perform one or more of the operations described herein.

### DETAILED DESCRIPTION

Aspects of the disclosure pertain to a method of showing multiple skippable advertisements associated with user requested content, such as video or audio content. Persuading viewers to watch advertisements is one method of monetizing content that is provided by a content sharing service (e.g., a social network, a content provider, content sharing platform for individual users, a network television content providing platform, etc.). Some content sharing services that serve advertisements to viewers allow viewers to skip an advertisement, e.g., after the advertisement has been displayed for a certain period of time, or the viewer can choose to not skip the advertisement and watch the advertisement through to completion. Advertisers may favor skippable advertisements because the advertiser does not have to pay an advertisement fee for advertisements that are skipped. However, if the viewer skips the advertisement, then the advertiser does not succeed in getting a message to the viewer, and the content provider (e.g., the content sharing service, the creator of the content, or other payable party) does not get paid the advertisement fee.

In some implementations, a method is provided to find advertisements that the viewer is willing to view, e.g., by allowing the viewer to skip a currently displayed advertisement such that a next advertisement is displayed. As a result, the viewer could be willing to view the advertisements without becoming irritated or overly annoyed. The viewer's annoyance might typically stem from the viewer feeling trapped or forced into viewing advertisements that the viewer has seen before or that the viewer is just not interested in viewing. By providing a means of letting a viewer have more control over what the viewer watches, the viewer can feel less trapped and happier about the viewing experience. Further, allowing the viewer to skip to a next advertisement provides the content provider and/or the advertiser with additional information about what the viewer is willing to view and which advertisements are more effective. As a result, embodiments provide an opportunity to monetize a viewer's viewing time more effectively.

According to embodiments, the viewer can be presented with multiple skippable advertisements in sequence. For example, the viewer can continue to skip advertisements until either advertising inventory runs out or the advertisements begin to repeat from the beginning. In another example, there are a maximum number of advertisements that the viewer can skip before the content is shown. In yet another example, the viewer might only have a limited number of skips available. This number of skips might be local to the current advertisement impression (e.g., the user is allowed a certain number of skips for a particular advertisement break before or during the presentation of the content), might span the length of the content or user session (e.g., the user is allowed a certain number of skips for all advertisement breaks before or during the presentation of the content), or might be temporally relevant or globally available (e.g., the user is allowed a certain number of skips during a certain time period regardless of how many content items are played by the user either on a certain device or any device). In another example, a viewer might be able to earn skips, e.g., by viewing certain content over a certain time. For example, if a viewer watches X seconds of advertisement or Y seconds of content, the viewer could earn the ability to skip one advertisement.

According to one embodiment, the viewer is required to view to completion a certain number of advertisements before the desired content is shown. In another embodiment, the viewer is required to view a certain total advertisement time, which can be summed from partial and/or complete advertisement views, before the desired content is shown. In yet another embodiment, the viewer is required to earn a certain advertisement viewing value, e.g., which may be calculated based on a score assigned to the advertisement being viewed, the advertisement length, and/or the portion of the advertisement viewed, prior to the desired content being shown.

A skip element can be provided for the viewer to select to skip an advertisement, according to embodiments. The skip element can include an indication about which advertisement the viewer will be shown next, e.g., if the viewer selects to skip the current advertisement. Additionally, the viewer can be provided with a skip to content element and/or a time-to-content element, according to an embodiment.

In one embodiment, the next advertisement in a series of advertisements can be selected based on the advertisement's length, the length of time that the viewer has already viewed advertisements, and/or skipped advertisements.

In an embodiment, the viewer is required to watch a certain length of the current advertisement before the viewer can skip to the next advertisement. For example, the appearance of the skip button changes (e.g., the skip button color or shape) when the viewer is permitted to skip. In another embodiment, the viewer may be able to skip to the next advertisement immediately.

An advertiser might be charged a different advertisement fee if the viewer skipped a previous advertisement because the action of skipping the advertisement indicates that the viewer is actually present to view the advertisement. Advertisers could indicate a position in the series of advertisements (e.g., first, second, third, etc.) where a particular advertisement should be shown or which advertisements the advertisement should or should not be shown near, and be charged a corresponding advertisement fee.

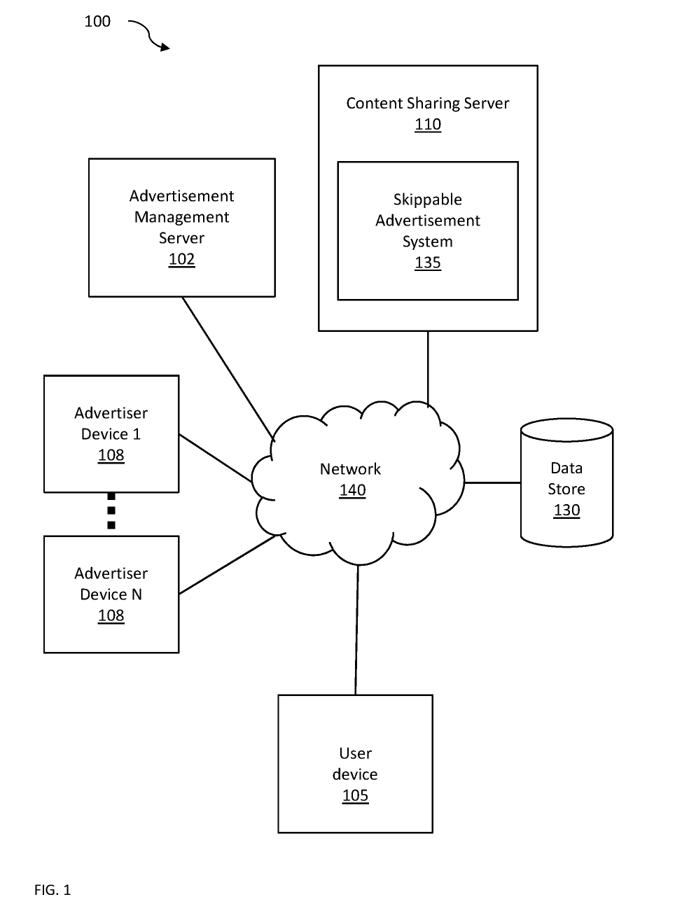

FIG. 1 illustrates exemplary system architecture 100, in accordance with one embodiment of the present disclosure. System 100 includes a user device 105, a content sharing server 110, an advertisement management server 102, advertiser devices 1-N 108, and a data store 130 in communication with (e.g., coupled to) with each other over a network 102, and. The network 102 may be a private network (e.g., a local area network (LAN), a wide area network (WAN), intranet, etc.), a corporate network (e.g., a private network for an organization such as a corporation), a broadcast network, a public network (e.g., the Internet), a wired network (e.g., Ethernet network), a wireless network (e.g., an 802.11 network) and/or a cellular network (e.g., a Long Term Evolution (LTE) network).

The user device 105 may be any type of computing device, for example, a device including a processor, a computer-readable medium, and a memory. In some embodiments, the user device 105 may be executing a browser application or other application adapted to communicate over Internet related protocols (e.g., TCP/IP and HTTP) and/or display a user interface. System 100 may support a large number of concurrent sessions with many client/user devices.

Each user device 105 can include a media viewer. In one implementation, the media viewers may be applications that allow users to view content items, such as images, videos, web pages, documents, etc. For example, the media viewer may be a web browser that can access, retrieve, present, and/or navigate content (e.g., web pages such as Hyper Text Markup Language (HTML) pages, digital media items, etc.) served by a web server. The media viewer may render, display, and/or present the content (e.g., a web page, a media viewer) to a user. The media viewer may also display an embedded media player (e.g., a Flash® player or an HTML5 player) that is embedded in a web page (e.g., a web page that may provide information about a product sold by an online merchant). In another example, the media viewer may be a standalone application that allows users to view digital media items (e.g., digital videos, digital images, electronic books, etc.). The media viewers may be provided to the user device 105 by the content sharing server 110. For example, the media viewers may be embedded media players that are embedded in web pages provided by the content sharing server 110. In another example, the media viewers may be applications that are downloaded from another server.

The content sharing server 110 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the disclosure may operate within a single server device or on multiple server devices.

In one embodiment, the content sharing server 110 provides content including content items (e.g., digital video, streaming video, images, digital music, streaming music, social media information, digital images, photographs, etc.) to the user device 105. For example, the content sharing server 110 may be part of a content sharing platform and may provide a media item, such as a streaming video, requested by a user for playback on the user device 105 via the network 102. The content sharing server 110 may represent a video hosting website, a news content provider, a social network site, or any other entity that provides media content (e.g., video or audio content) to the user devices 105.

Data store 130 can store media content or links to media content and can include one or more writable persistent storage devices, such as memories, tapes or disks. Although the content sharing server 110 and data store 130 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

During operation of system 100, a user requests a content item (e.g., video or audio content) via the user device 105 over network 102. The content sharing server 110 receives the request, and responds to the request by providing the requested content item with a set of skippable advertisements targeting the requested content item.

In some implementations, the content sharing server 110 can determine what advertisement(s) to provide with the requested content item using the advertisement management server 102. The advertisement management server 102 can be an independent system and can include one or more computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Alternatively, the advertisement management server 102 can be hosted by the same machine(s) as the content sharing server 102.

In some implementations, advertisers can access the advertisement management server 102 via advertiser devices 108 to enter, maintain and track advertisement information. The advertisement management server 102 may provide a list of available advertisement placements and corresponding prices for the available placements to the advertisers. A placement may refer to any web or user interface (UI) property that can enable the presentation of advertisements. A web or UI property can represent, for example, a search result UI, a watch page UI, a website, a subset of web pages, or any other network distributed content, etc. An advertiser can specify one or more targeting criteria (e.g., type of content, type of UI, etc.) to select placements on which the advertiser would like to place the ads. The advertisement management server 102 may then store the associations between the selected placements and the corresponding ads. The ads may include graphical ads (e.g., banner ads), text only ads, image ads, audio ads, video ads, etc. The ads may also include embedded information, such as a link, meta-information, and/or machine executable instructions.

The content sharing server can include a skippable advertisement system 135. In some implementations, the skippable advertisement system 135 can obtain a first in a set of advertisements (e.g., a set of sequential advertisements) to provide to the user device 105 for display, e.g., via a media player.

As the first advertisement is currently displayed (or presented), the user is provided with the option to select to skip the advertisement (e.g., via a skip element), which may be provided immediately or after a certain period of time (e.g., 5 seconds). The user may also be provided with an indication of the next advertisement in the series of advertisements and/or a duration of the currently displayed advertisement, which may influence whether the user will select to skip the current advertisement. In some embodiments, the user may be provided with the option to select to skip to viewing the requested content.

If the user does not select to skip the current advertisement, then the current advertisement is displayed to completion. If the user selects to skip the current advertisement, then the advertisement system 135 obtains a next advertisement in the set of advertisements. Again, the user may be provided with the option to select to skip the advertisement or view the advertisement to completion.

The skippable advertisement system 135 can continue to obtain a next advertisement in the set of advertisements and provide the option to skip the current advertisement, until an advertisement viewing criterion (e.g., a threshold advertisement viewing criterion) is met. The skippable advertisement system 135 can determine whether the user has met the advertisement viewing criterion, which can be a threshold total number of advertisement (e.g., one advertisement, two advertisements, three advertisement, etc.), a threshold total time of advertisement viewing (e.g., 30 seconds, one minute, two minutes, etc.), or a threshold total advertisement value (e.g., 60 points) where each advertisement is worth a certain number of points (e.g., a 30 second advertisement that is shown first is worth 30 points, a 30 second advertisement that is shown second is worth 60 points, a 60 second advertisement that is shown fourth is worth 20 points, etc.). The advertisement viewing criterion can be defined by a content owner, content creator, an end user, etc. Alternatively, the advertisement viewing criterion can be set automatically (without any user input) by the content sharing server 110.

Once the advertisement viewing criterion is met, then the skippable advertisement system 135 can indicate that the requested content can be provided for display to the viewer.

The content sharing server 110 can obtain advertisements using the advertisement management server 102. In some implementations, the content sharing server 110 may submit an advertisement request to the advertisement management server 102 upon receiving a content item request from the user device 105. The advertisement request submitted by the content sharing server 110 may include content item request information such an identifier of the requested content item, a category corresponding to the requested content item (e.g., business, movies, music, etc.), content item type (e.g., video, audio, etc.), content item age, geo-location information, etc.

Upon receiving an advertisement request from the content providing system 110, the advertisement management server 102 may select one or more ads matching the content item request information, and provide the selected ads to the content sharing server 110.

In one implementation, the ads selected by the advertisement management server 102 are auctioned to determine what ads should be returned to the content sharing server 110 and/or the order in which they should be presented to the user. This determination may depend on, for example, other advertisers' bids (e.g., the maximum amount an advertiser will pay per user click on an advertisement) and/or the performance scores of the ads. The performance score of an ad may be calculated based on, for example, historical click-through rates, relevance of an advertiser's ad text and keywords, an advertiser's account history, etc. In another implementation, the ads are selected by the advertisement management server 102 on a reservation basis (e.g., based on predefined conditions) without taking into account other advertisers' bids and/or the performance scores of the ads.

In situations in which the systems discussed herein collect personal information about users, or may make use of personal information, the users may be provided with an opportunity to control whether the content sharing platform 110 collects user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the content sharing platform 110

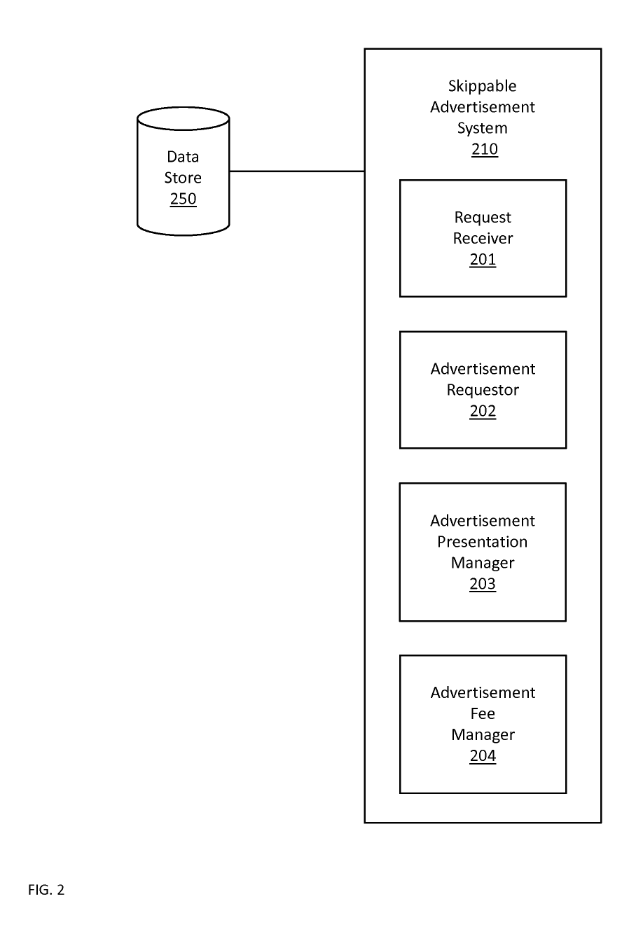

FIG. 2 illustrates an advertisement system 210, in accordance with one embodiment of the present disclosure. The advertisement system 210 may include a request receiver 201, an advertisement requestor 202, an advertisement presentation manager 203, and an advertisement fee manager 204. More or less components may be included in the advertisement system 210 without loss of generality. In an embodiment, skippable advertisement system 210 is skippable advertisement system 135 and data store 250 is data store 130, which are shown in FIG. 1.

In an embodiment, the request receiver 201 receives an indication of a request (e.g., via a content sharing server, such as length, subject matter, source, etc.) from a user via a user device for a certain content item, e.g., stored in a data store 250. The request receiver 201 can also identify characteristics of the content item. The request receiver 201 can request that the advertisement requestor 202 obtain a set (or series) of advertisements (e.g., based on the characteristics of the content item) and provide an indication that a first advertisement of the set advertisements should be provided to the user device for presentation.

In an embodiment, the advertisement requestor 202 requests the set of advertisements from an advertisement management server (e.g., advertisement management server 102 of FIG. 1). A certain set of advertisements is received based on the content that was requested. For example, an advertiser can request that a certain advertisement be provided in association with certain content. Furthermore, an advertiser can request that a certain advertisement be provided in a certain position in the series of advertisements (e.g., first in the series, third in the series, etc.). In an embodiment, the information regarding suitable advertisements can reside at the advertisement management server.

Once the first advertisement of the selected set of advertisements is presented for display, the user is also provided with an option to select to skip the advertisement (e.g., a skip element) if the user desires, along with an indication of the next advertisement and/or a duration of the current advertisement. The user can either view the advertisement to completion or select to skip the advertisement, e.g., immediately or after a certain period of time.

If the user views the advertisement to completion, then the advertisement presentation manager 203 determines whether an advertisement viewing criterion for the requested content has been met. If the advertisement viewing criterion has been met, then the advertisement presentation manager 203 can provide an indication (e.g., to a content sharing server) that the requested content can now be provided to the user device for viewing.

For example, if the viewing of only one advertisement is required by the advertisement viewing criterion and the user has viewed the first advertisement to completion, then the advertisement viewing criterion has been met, and the user can then view the requested content. If the viewing of more than one advertisement (e.g., two advertisements) is required by the advertisement viewing criterion, then the advertisement presentation manager 203 indicates that another advertisement should be shown. Another advertisement (e.g., the next advertisement or another advertisement based on the advertisement already provided) can then be presented for display.

If the viewing of a certain duration of advertisements is required (e.g., 60 seconds), then the advertisement presentation manager 203 can determine whether the advertisement duration has met the required duration of advertisements. If the duration has been met, then the advertisement presentation manager 203 can indicate that the requested content should be presented for display. If the duration has not been met, then the advertisement presentation manager 203 can indicate that another advertisement should be presented for display.

If the user selects to skip the current advertisement (e.g., via the skip element), the request receiver 201 receives the request to skip and requests that the advertisement presentation manager 203 determine whether the advertisement viewing criterion has been met. If the advertisement viewing criterion has been met, then an indication can be provided (e.g., to a content sharing server) that the requested content should be provided to the user device. If the advertisement viewing criterion has not been met, then the advertisement presentation manager 203 can indicate that another advertisement (e.g., a next advertisement of the set of advertisements or another advertisement based on the previous advertisement) should be presented for display to the user device. The advertisement system 210 continues to provide an indication that another advertisement should be presented for display to the user device until the advertisement viewing criterion is met. Once the advertisement viewing criterion is met, then an indication can be sent that the requested content should be provided to the user device.

In an embodiment, an advertisement fee manager 204 can calculate a fee that should be charged to the advertiser. For example, the fee can be based on whether the entire advertisement was shown or only a portion of the advertisement was shown, such that a smaller fee or no fee is charged. The fee can also be based on a position in the order of advertisements that the advertisement was shown (e.g., advertisements shown later in the order could have a higher or lower fee).

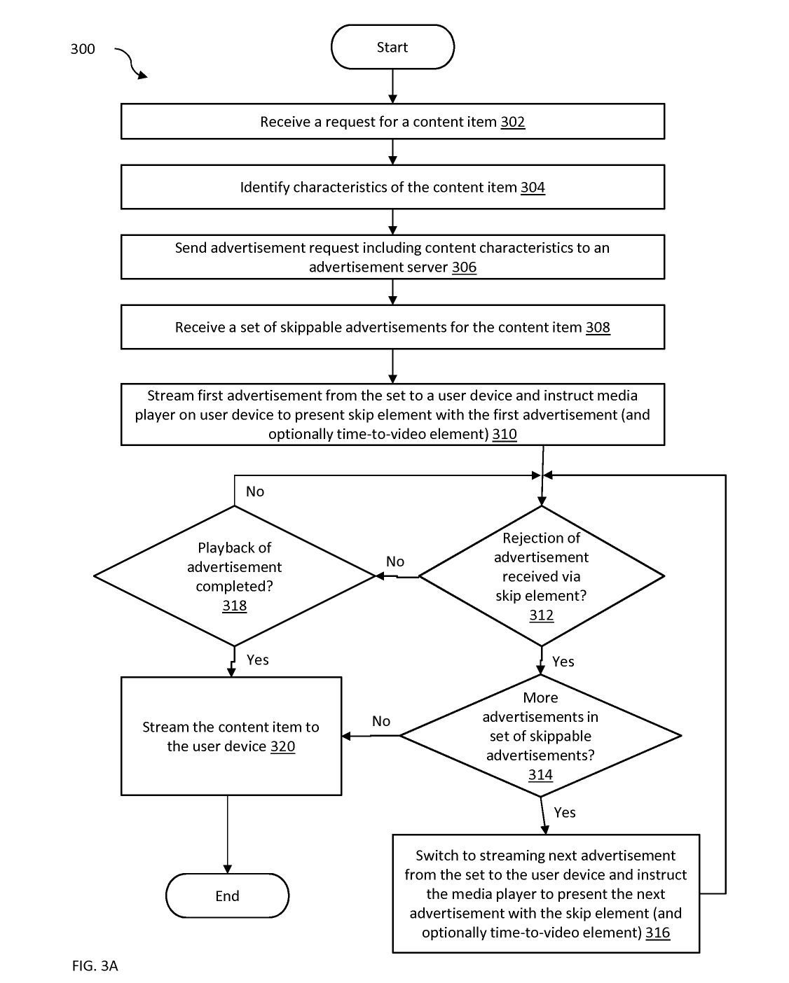

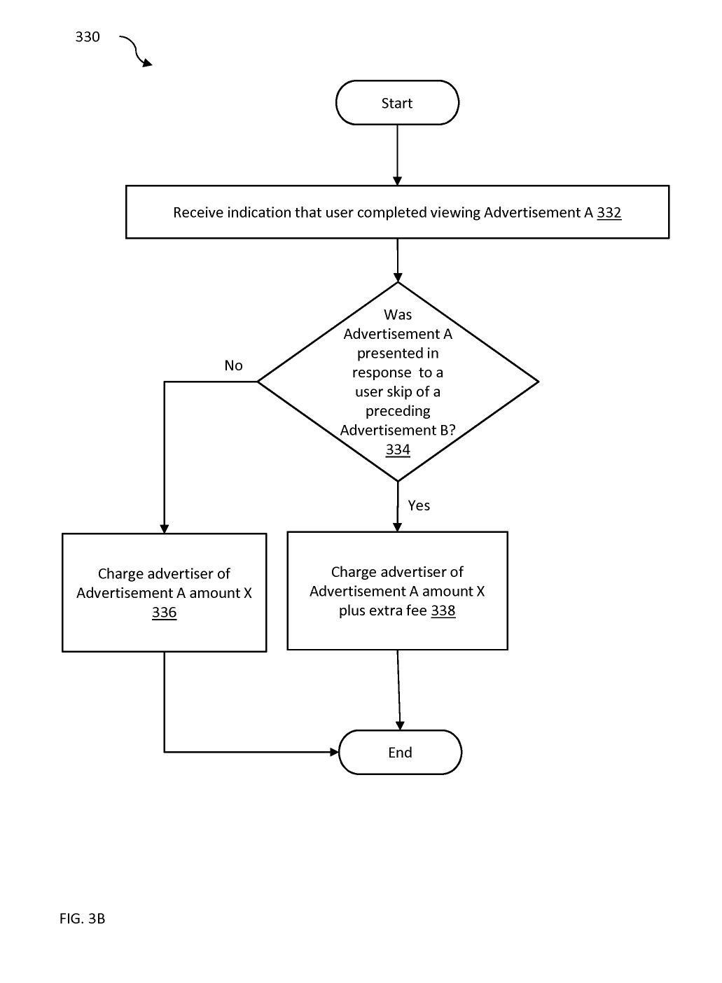

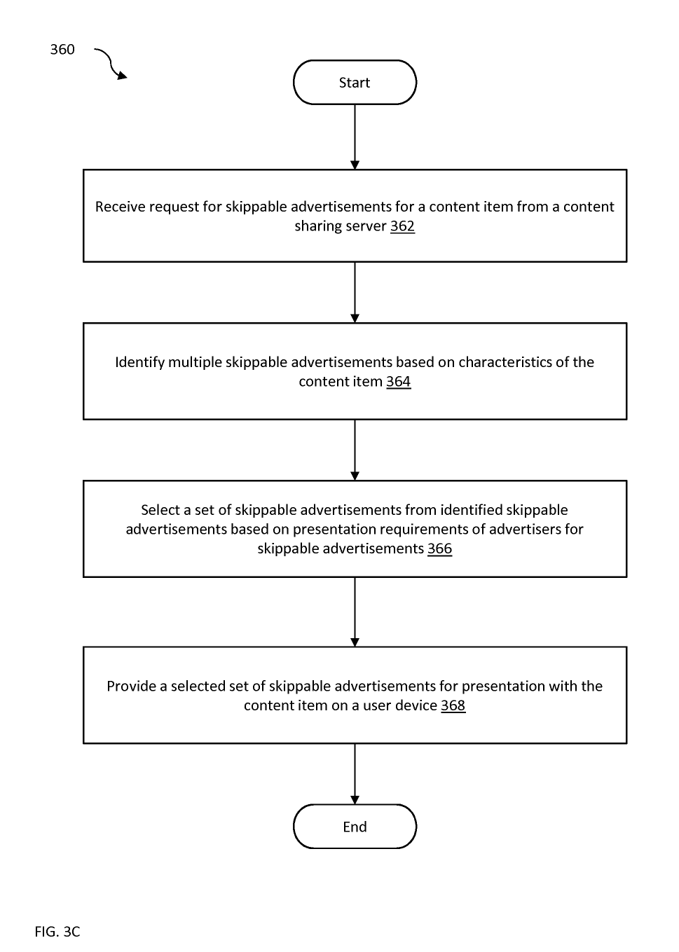

FIG. 3A is a flow diagram illustrating an embodiment for a method 300 of showing multiple skippable advertisements. The method 300 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by a server (e.g., the content sharing server 110 of FIG. 1).

At block 302, processing logic receives a request for a content item, such as a request for a content item from a user using a user device.

At block 304, processing logic can identify characteristics of the content item. For example, the characteristics can include a length of the content, a subject matter of the content, a number of advertising breaks, etc.

At block 306, processing logic can send an advertisement request including the content characteristics to an advertisement server (e.g., an advertisement management server). At block 308, processing logic can receive a set of skippable advertisements for the content item 308, e.g., from an advertisement server as discussed in greater detail below in conjunction with FIG. 3C. In an example, the set of skippable advertisements can be selected based on the content characteristics. In one example, a request is received from a user via a user device for Content A. Based on the content characteristics of Content A, Set of Skippable Advertisements Z is received, e.g., from the advertisement server.

At block 310, processing logic streams a first advertisement from the set of advertisements to the user device and instructs a media player on the user device to present a skip element with the first advertisement. Optionally, a time-to-video element, e.g., where the time remaining in the advertisement before display of the content is displayed, and/or a next advertisement indicator can also be displayed.

At block 312, processing logic determines whether the user has rejected the advertisement being displayed, e.g., via a skip element. If the user has rejected the advertisement, then, at block 314, processing logic determines whether there are more advertisements in the set of skippable advertisements. If there are more advertisements in the set of skippable advertisements, then, at block 316, processing logic switches to streaming a next advertisement from the set of advertisement to the user device and instructs the media player to present the next advertisement with the skip element. Optionally, the time-to-video element is also displayed.

In an implementation, a user may continue to skip advertisements, and, e.g., the advertisements in the set of advertisements would begin to repeat after all of the advertisements had been skipped once. In another implementation, a user may be allowed only a certain number of skips. In yet another implementation, a user may only skip an advertisement after display of the advertisement for a certain amount of time. In another implementation, a user may only be allowed a certain number of skips per time period (e.g., 3 skips every 10 minutes).

In an implementation, a user can select a next advertisement, e.g., from a listing of the set of advertisements. In one implementation, the skip element changes (e.g., changes text, color, graphics, etc.) to indicate that the current advertisement can be skipped.

For example, a user of the user device can select to skip the current advertisement, e.g., immediately or after a certain period. The user may also be provided with an indication of the next advertisement that will be displayed and/or a duration of the current advertisement. Further to the example above, the user is provided with an option to skip Advertisement 1 of Set of Skippable Advertisements Z after Advertisement 1 has been displayed for 5 seconds, and may also be provided with an indication that Advertisement 2 of Set of Skippable Advertisements Z will be displayed next and that display of Advertisement 1 will be completed in 25 seconds. For example, the user can select to skip Advertisement 1 (e.g., because the user is not interested in the product advertised in Advertisement 1, and finds a thumbnail indicating Advertisement 2 to be more interesting).

After streaming of the next advertisement begins, at block 312, processing logic again determines whether a rejection of the advertisement has been received via a skip element 312. If a rejection of the currently displayed advertisement is not received, then, at block 318, processing logic determines whether playback of the current advertisement has completed. If playback of the advertisement is not completed, then, at block 312, processing logic again determines whether a rejection of the advertisement has been received via the skip element, such that the advertisement continues to play to completion as long as the user does not skip the advertisement.

If playback of the advertisement is completed, then, at block 320, processing logic streams the requested content item to the user device. Further to the example above, Content A can now be provided to the user.

Optionally, processing logic also determines whether an advertisement viewing criterion has been met. For example, the user may have met the advertisement viewing criterion if advertisements have been displayed for a duration defined by the advertisement viewing criterion, or the user may have met the advertisement viewing criterion if a certain number of advertisements have been displayed. For example, if the advertisement viewing criterion is display of one complete advertisement and the user has not selected to skip the first advertisement that was displayed, then the advertisement viewing criterion is met. If the advertisement viewing criterion is display of one complete advertisement and the user has selected to skip the first advertisement that was displayed, then the advertisement viewing criterion is not met.

In an embodiment, whether an advertisement viewing criterion has been met can be continually determined or determined prior to a completion of a currently displayed advertisement. For example, if advertisement requirement is 50 seconds, once 50 seconds of advertisement have been displayed in total, the advertisement viewing criterion is met and advertisements will cease to be shown. In another embodiment, the currently displayed advertisement will be shown to completion even though the advertisement viewing requirement has been met, unless a user selects to skip the advertisement.

In an embodiment, if the user selects to skip an advertisement, prior to a next advertisement being displayed, processing logic can first determine whether an advertisement viewing criterion has been met. If the advertisement viewing criterion has been met, then a next advertisement is not shown.

If the advertisement viewing criterion is not met, a next advertisement is provided. Further to the example above, the advertisement viewing criterion is two advertisements. Because the user has selected to skip the Advertisement 1, the advertisement viewing criterion is not met. Therefore, Advertisement 2 is provided for display, which the user does not skip. However, the advertisement viewing criterion is still not met, because two advertisements must be displayed to completion for the advertisement viewing criterion to be met. As a result, Advertisement 3 is provided for display, which the user does not skip. Once Advertisement 3 is displayed to completion, then the advertisement viewing criterion is met.

FIG. 3B is a flow diagram illustrating an embodiment for a method 330 of calculating an advertisement fee. The method 330 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by a server (e.g., the content sharing server 110 of FIG. 1).

At block 332, processing logic receives an indication that a user has completed viewing an Advertisement A. At block 334, processing logic determines whether Advertisement A was presented in response to a user skipping a preceding Advertisement B. If Advertisement A was not presented in response to the user skipping Advertisement B, then, at block 336, processing logic charges the advertiser of Advertisement A an amount X. If Advertisement A was presented in response to the user skipping Advertisement B, then, at block 338, processing logic charges the advertiser of Advertisement A the amount X plus an extra fee. For example, because the user skipped Advertisement A, the user is likely to be present and paying attention to what is being displayed so the advertiser of Advertisement B pays a premium for Advertisement B to be displayed after a skipped advertisement

FIG. 3C is a flow diagram illustrating an embodiment for a method 360 of providing multiple skippable advertisements. The method 360 may be performed by processing logic that may include hardware (e.g., circuitry, dedicated logic, programmable logic, microcode, etc.), software (e.g., instructions run on a processing device to perform hardware simulation), or a combination thereof. In one embodiment, the method 300 is performed by a server (e.g., the advertisement management server 102 of FIG. 1).

At block 362, processing logic receives a request for a set of skippable advertisements for a content item from a content sharing server. The request can be in response to a user requesting the content item for display from a user device. The request can include characteristics of the content item.

At block 364, processing logic identifies multiple skippable advertisements based on the characteristics of the content item. At block 366, processing logic selects a set of skippable advertisements from the identified skippable advertisements based on presentation requirements of advertisers for skippable advertisements. For example, the characteristics can include a content type and duration, so the set of multiple skippable advertisements can be selected based on the content type and duration. In one example, an advertiser can indicate the type of content and the durations of the content where the advertiser would like a particular advertisement to be placed. As such, advertisements with commensurate these types and durations can be selected.

At block 368, processing logic provides a selected set of skippable advertisements for presentation with the content item on the user device.

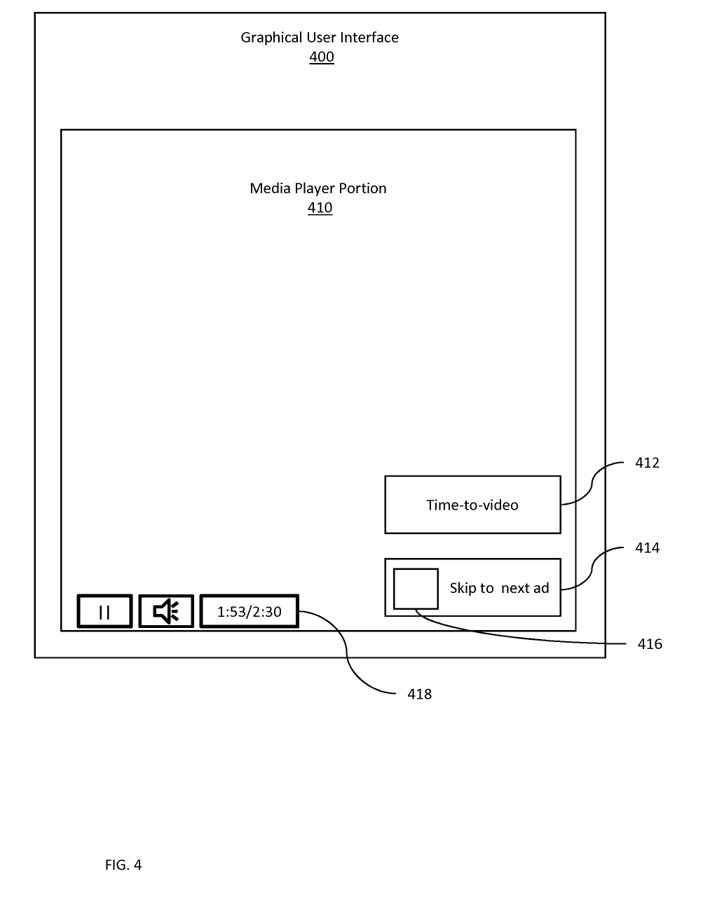

FIG. 4 is illustrates a graphical user interface 400 according to an embodiment (e.g., on a display of the user device 105 of FIG. 1). The graphical user interface 400 can include a media player portion 410. The media player portion 410 can display a time-to-video indicator 412 (e.g., indicating a time remaining for playback of the current advertisement before either a next advertisement or a requested content item is displayed) and a skip element 414 (e.g., a button labeled “skip to next ad”) that a user can select to skip a currently displayed advertisement. The skip element 414 can optionally include an ad image 416, which displays a thumbnail, screen capture, or other indicator of the subject matter of the next advertisement. Element 418 can indicate an elapsed time of content display.

For example, the skip element 414 can be a button that a user can select or click on to indicate that the user desires to skip the currently displayed advertisement. Upon selecting the skip element, display of the current advertisement should be halted and display of a next advertisement should begin.

In another example, the time-to-video indicator 412 can indicate a total duration of the currently displayed advertisement and/or the time remaining for completion of display of the currently displayed advertisement. For example, the time-to-video indicator 412 could indicate that a currently displayed advertisement is 30 seconds long and/or that 15 seconds remain before completion of display. This duration and time remaining information could be of interest to the user in determining whether or not to skip the currently displayed advertisement. For example, if there are only a few second remaining in the currently displayed advertisement, the user may determine that completing display of that advertisement is optimal. However, if the user dislikes the currently displayed advertisement and there is a significant amount of time left until completion of display of the advertisement, then the user may determine that skipping that advertisement is optimal.

In yet another example, the ad image 416 can indicate a next advertisement that will be displayed after the current advertisement. For example, the next advertisement could be the advertisement that will be displayed if the current advertisement is skipped and/or the advertisement that will be displayed if the current advertisement is displayed to completion. For example, the ad image 416 could indicate a sponsor of the next advertisement, show a thumbnail graphic from the next advertisement, show a product included in the next advertisement, and/or show any other suitable indicator of the next advertisement. Further, the ad image 416 could indicate a length of the next advertisement.

In an implementation, the skip element 414 can be modified to indicate that selection of the skip element 414 will skip to a requested content item, e.g., when an advertisement viewing criterion is met.

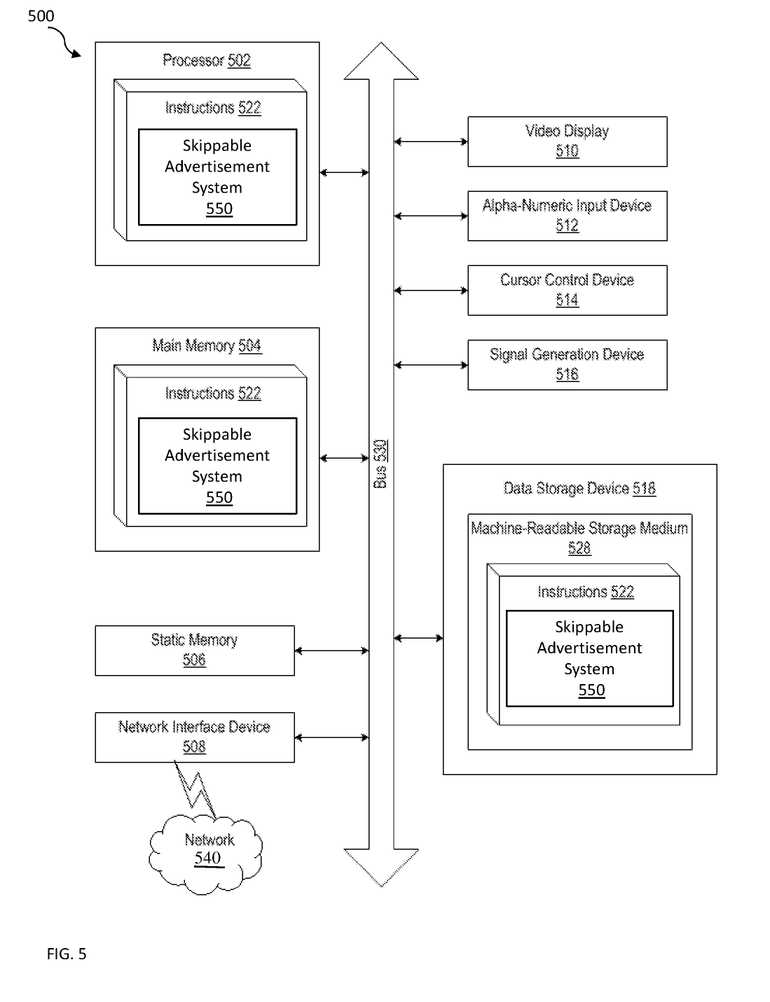

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-readable storage medium 528 (or computer-readable storage medium) on which is stored one or more sets of instructions 522 (e.g., software) embodying any one or more of the methodologies or functions described herein. The instructions 522 may also reside, completely or at least partially, within the main memory 504 and/or within the processor 502 during execution thereof by the computer system 500, the main memory 504 and the processor 502 also constituting computer-readable storage media. The instructions 522 may further be transmitted or received over a network 516 via the network interface device 508.

In one embodiment, the instructions 522 include instructions for an skippable advertisement system 550, which may correspond to skippable advertisement system 135 of FIG. 1, and/or a system for providing skippable advertisements. While the machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing, encoding or carrying a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A method of controlling a presentation of advertisements, the method comprising:
receiving, by a request receiver circuit of a server computing system through a user interface of a user device, a request for a content item;
providing, by an advertisement requestor circuit of the server computing system, a set of advertisements based on a presentation requirement of a provider encoded in a user interface property, the presentation requirement comprising at least a content type and a presentation requirement duration, wherein one advertisement in the set of advertisements is provided prior to all other advertisements in the set based on the presentation requirement;
identifying, by a processing device of the server computing system, an advertisement viewing criterion for the set of advertisements, wherein the advertisement viewing criterion comprises a threshold time period that is less than a total duration of the set of advertisements;
causing, by the server computing system, the first advertisement and a skip element to be presented on the user device, the skip element being presented concurrently with a presentation of the first advertisement and providing an option to skip the first advertisement when the skip element is enabled;
causing, by the server computing system, the time-to-video element to be presented on the user device, the time-to-video element updated while the user is viewing the first advertisement;
receiving an indication of completion of the first advertisement;
responsive to receiving the indication of completion of the first advertisement, determining whether the advertisement viewing criterion is satisfied; and
either:
responsive to determining the advertisement viewing criterion is satisfied causing the content item to be presented on the user device; or
responsive to determining the advertisement viewing criterion is not satisfied, determining a difference, by the processing device of the server computing system, between a combined duration of presentations of two or more advertisements and the threshold time period of the advertisement viewing criterion,
selecting a second advertisement having a duration greater than the presentation requirement duration, wherein the duration is based on the determined difference between the combined duration of presentations and the threshold time period,
causing the second advertisement of the set of advertisements to be presented on the user device,
in response to determining the advertisement viewing criterion is satisfied by presentation of the second advertisement, providing an option to skip the second advertisement to the content item prior to a completion of the set of advertisements, whereby the skip element is enabled, and
causing the content item to be presented on the user device, responsive to detection of a user interaction with the skip element.

2. The method of claim 1, wherein the advertisement viewing criterion further comprises a threshold number of advertisements to be watched prior to a presentation of the content item.

3. The method of claim 1, wherein the advertisement viewing criterion comprises the threshold time period is defined by at least one of a content owner, a content creator, an end user, or a content sharing service.

4. The method of claim 1, wherein each advertisement of the set of advertisements has a corresponding advertisement viewing value, and wherein the advertisement viewing criterion further comprises a threshold advertisement viewing value.

5. The method of claim 1, wherein the skip element indicates a skip to a next advertisement, the skip element comprising at least one of a graphical representation of the next advertisement or the title of the next advertisement.

6. (canceled)

7. The method of claim 1, wherein the second advertisement is selected based on at least one of a presentation period of the second advertisement, a user viewing time of previous advertisements, or a number of previously skipped advertisements.

8. The method of claim 1, wherein causing the second advertisement to be presented on the user device comprises ensuring that the first advertisement was presented for at least a predefined time period.

9. The method of claim 1, wherein the set of advertisements is formed based on advertiser input indicating advertisements to be shown together, and wherein the set of advertisements has a sequential order.

10. The method of claim 1, further comprising:
receiving an indication that a user has completed viewing the second advertisement;
determining that the second advertisement was presented in response to the user skipping the presentation of the first advertisement; and
charging an advertiser of the second advertisement an additional fee.

11. (canceled)

12. A non-transitory computer readable storage medium having instructions for controlling a presentation of advertisements, the instructions, when executed by a processing device, cause the processing device to perform operations comprising:
receiving, by a request receiver circuit of a server computing system through a user interface of a user device, a request for a content item;
providing, by an advertisement requestor circuit of the server computing system, a set of advertisements based on a presentation requirement of a provider encoded in a user interface property, the presentation requirement comprising at least a content type and a presentation requirement duration, wherein one advertisement in the set of advertisements is provided prior to all other advertisements in the set based on the presentation requirement;
identifying an advertisement viewing criterion for the set of advertisements, wherein the advertisement viewing criterion comprises a threshold time period that is less than a total duration of, the set of advertisements;
causing the first advertisement and a skip element to be presented on the user device, the skip element being presented concurrently with a presentation of the first advertisement and providing an option to skip the first advertisement when the skip element is enabled;
causing, by the server computing system, the time-to-video element to be presented on the user device, the time-to-video element updated while the user is viewing the first advertisement;
receiving an indication of completion of the first advertisement;
responsive to receiving the indication of completion of the first advertisement, determining whether the advertisement viewing criterion is satisfied; and
either:
responsive to determining the advertisement viewing criterion is satisfied causing the content item to be presented on the user device; or
responsive to determining the advertisement viewing criterion is not satisfied, determining a difference, by the processing device of the server computing system, between a combined duration of presentations of two or more advertisements and the threshold time period of the advertisement viewing criterion,
selecting a second advertisement having a duration greater than the presentation requirement duration, wherein the duration is based on the determined difference between the combined duration of presentations and the threshold time period,
causing the second advertisement of the set of advertisements to be presented on the user device,
in response to determining the advertisement viewing criterion is satisfied by presentation of the second advertisement, providing an option to skip the second advertisement to the content item prior to a completion of the set of advertisements, whereby the skip element is enabled, and
causing the content item to be presented on the user device, responsive to detection of a user interaction with the skip element.

13. The non-transitory computer readable storage medium of claim 12, wherein the advertisement viewing criterion further comprises a threshold number of advertisements to be watched prior to a presentation of the content item.

14. The non-transitory computer readable storage medium of claim 12, wherein the advertisement viewing criterion comprises the threshold time period is defined by at least one of a content owner, a content creator, an end user, or a content sharing service.

15. The non-transitory computer readable storage medium of claim 12, wherein each advertisement of the set of advertisements has a corresponding advertisement viewing value, and wherein the advertisement viewing criterion further comprises a threshold advertisement viewing value.

16. The non-transitory computer readable storage medium of claim 12, wherein the skip element indicates a skip to a next advertisement, the skip element comprising at least one of a graphical representation of the next advertisement or the title of the next advertisement.

17. The non-transitory computer readable storage medium of claim 16, wherein the skip element is modified to indicate a skip to the content item when the next advertisement is presented.

18. The non-transitory computer readable storage medium of claim 12, wherein the second advertisement is selected based on at least one of a presentation period of the second advertisement, a user viewing time of previous advertisements, or a number of previously skipped advertisements.

19. The non-transitory computer readable storage medium of claim 12, wherein causing the second advertisement to be presented on the user device comprises ensuring that the first advertisement was presented for at least a predefined time period.

20. The non-transitory computer readable storage medium of claim 12, wherein the set of advertisements is formed based on advertiser input indicating advertisements to be shown together, and wherein the set of advertisements has a sequential order.

21. The non-transitory computer readable storage medium of claim 12 further comprising:
receiving an indication that the user has completed viewing the second advertisement;
determining that the second advertisement was presented in response to the user skipping the presentation of the first advertisement; and
charging an advertiser of the second advertisement an additional fee.

22. A computing device for controlling a presentation of advertisements, the computing device comprising:
a memory; and
a processing device coupled to the memory, wherein the processing device is configured to:
receive, by a request receiver circuit of a server computing system through a user interface of a user device, a request for a content item;
provide, by an advertisement requestor circuit of the server computing system, a set of advertisements based on a presentation requirement of a provider encoded in a user interface property, the presentation requirement comprising at least a content type and a presentation requirement duration, wherein one advertisement in the set of advertisements is provided prior to all other advertisements in the set based on the presentation requirement;
identify an advertisement viewing criterion for the set of advertisements, wherein the advertisement viewing criterion comprises a threshold time period that is less than a total duration of the set of advertisements;
cause the first advertisement and a skip element to be presented on a user device, the skip element being presented concurrently with a presentation of the first advertisement and providing an option to skip the first advertisement when the skip element is enabled;
cause, by the server computing system, the time-to-video element to be presented on the user device, the time-to-video element updated while the user is viewing the first advertisement;
receive an indication of completion of the first advertisement;
responsive to receiving the indication of completion of the first advertisement, determine whether the advertisement viewing criterion is satisfied; and
either:
responsive to determining the advertisement viewing criterion is satisfied cause the content item to be presented on the user device; or
responsive to determining the advertisement viewing criterion is not satisfied, determine a difference, by the processing device of the server computing system, between a combined duration of presentations of two or more advertisements and the threshold time period of the advertisement viewing criterion,
select a second advertisement having a duration greater than the presentation requirement duration, wherein the duration is based on the determined difference between the combined duration of presentations and the threshold time period,
cause the second advertisement of the set of advertisements to be presented on the user device;
in response to determining the advertisement viewing criterion is satisfied by presentation of the second advertisement, provide an option to skip the second advertisement to the content item prior to a completion of the set of advertisements, whereby the skip element is enabled, and
cause the content item to be presented on the user device responsive to detection of a user interaction with the skip element.

23. The computing device of claim 22, wherein the advertisement viewing criterion further comprises a threshold number of advertisements to be watched prior to a presentation of the content item.

24. The computing device of claim 22, wherein the advertisement viewing criterion comprises the threshold time period is defined by at least one of a content owner, a content creator, an end user, or a content sharing service.

25. The computing device of claim 22, wherein each advertisement of the set of advertisements has a corresponding advertisement viewing value, and wherein the advertisement viewing criterion further comprises a threshold advertisement viewing value.

26. The computing device of claim 22, wherein the skip element indicates a skip to a next advertisement, the skip element comprising at least one of a graphical representation of the next advertisement or the title of the next advertisement.

27. The computing device of claim 22, wherein the skip element is modified to indicate a skip to the content item when the next advertisement is presented.

28. The computing device of claim 22, wherein the second advertisement is selected based on at least one of a presentation period of the second advertisement, a user viewing time of previous advertisements, or a number of previously skipped advertisements.

29. The computing device of claim 22, wherein the set of advertisements is formed based on advertiser input indicating advertisements to be shown together, and wherein the set of advertisements has a sequential order.

30. The computing device of claim 22, wherein the processing device is further to:
receiving an indication that a user has completed viewing the second advertisement;
determining that the second advertisement was presented in response to the user skipping the presentation of the first advertisement; and
charging an advertiser of the second advertisement an additional fee.

31. The method of claim 1, further comprising, in response to determining the advertisement viewing criterion is satisfied, modifying the skip element from skipping to a next advertisement in the set to skipping past the next advertisement to the content item.
